(19) United States
(12) Patent Application Publication
(10) Pub. No.: US 2026/0351466 A1
(43) Pub. Date: Nov. 5, 2026

(54) INDUCTOR AND MANUFACTURING METHOD FOR INDUCTOR

(71) Applicant: Murata Manufacturing Co., Ltd., Kyoto-fu (JP)

(72) Inventors: Naoto TAKAHASHI, Nagaokakyo-shi (JP); Yoichi NAKATSUJI, Nagaokakyo-shi (JP)

(73) Assignee: Murata Manufacturing Co., Ltd., Kyoto-fu (JP)

(21) Appl. No.: 19/724,262

(22) Filed: Jun. 29, 2026

Related U.S. Application Data
(63) Continuation of application No. PCT/JP2024/041415, filed on Nov. 22, 2024.

(30) Foreign Application Priority Data
Feb. 27, 2024 (JP) 2024-027622

(51) Int. Cl. H01F 27/28; H01F 27/255; H01F 27/29; H01F 27/32; H01F 37/00; H01F 41/10; H01F 41/12

(52) U.S. Cl. CPC H01F 27/2828; H01F 27/255; H01F 27/292; H01F 27/327; H01F 41/10; H01F 41/127; H01F 37/00

(57) ABSTRACT

An inductor includes a coil conductor having a pair of extended portions formed of a conductive wire having a conductor and an insulating coating covering a periphery of the conductor, an element body that contains magnetic particles and a resin and includes the coil conductor, and an outer electrode connected to an exposed part of the extended portion that is exposed from a surface of the element body. In at least one extended portion, in the exposed part, the conductor of the conductive wire is exposed from an opening of the insulating coating and extends on the surface of the element body, and the area of an exposed surface of the conductor extending on the surface of the element body is larger than the area of the opening of the insulating coating.

### CROSS-REFERENCE TO RELATED APPLICATIONS

This application claims benefit of priority to International Patent Application No. PCT/JP2024/041415, filed Nov. 22, 2024, and to Japanese Patent Application No. 2024-027622, filed Feb. 27, 2024, the entire contents of each are incorporated herein by reference.

### BACKGROUND

### Technical Field

The present disclosure relates to an inductor and a manufacturing method for an inductor.

### Background Art

Japanese Unexamined Patent Application Publication No. 2016-58418 describes an inductor having a coil conductor, an element body that contains metal magnetic particles and a resin and includes the coil conductor, and a pair of outer electrodes electrically connected to ends of the coil conductor. In this inductor, surfaces of extended portions of the coil conductor are exposed at an element body surface. Further, in portions of the element body surface where the outer electrodes are formed, plated layers are formed after the resin contained in the element body is removed. Thus, the metal magnetic particles contained in the element body, the extended portions, and the outer electrodes including the plated layers are electrically connected.

### SUMMARY

In the above conventional inductor, for example, when the coil conductor is formed of a conductive wire having a conductor and an insulating coating, after the element body is formed such that the extended portions of the coil conductor are exposed, laser light is applied to an outer-electrode formation region on the element body surface including the exposed part of the extended portion. Thereby, the resin on the element body surface is removed, and the insulating coating of the extended portion exposed at the element body surface is removed. At this time, in the vicinity of a contour part of the extended portion exposed at the element body surface (that is, a boundary portion between the surface of the exposed extended portion and the element body surface at the periphery thereof), a remaining portion of the insulating coating may occur due to failure in sufficient removal of the insulating coating of the conductive wire of the extended portion. Such a remaining portion of the insulating coating not only reduces the connection area between the conductor of the extended portion and the outer electrode but also becomes a portion to which a plated metal does not adhere when the outer electrode is formed by metal plating in a subsequent step, and possibly adversely affects adhesion strength between the extended portion and the outer electrode and direct current resistance.

Accordingly, the present disclosure suppresss formation of an outer electrode on an insulating coating of an extended portion exposed at a surface of an element body to improve adhesion strength between the extended portion and the outer electrode and reduce direct current resistance in an inductor in which a coil conductor having a pair of extended portions formed of a conductive wire having a conductor and the insulating coating is included in the element body containing magnetic particles and a resin.

An aspect of the present disclosure provides an inductor including a coil conductor having a pair of extended portions formed of a conductive wire having a conductor and an insulating coating covering a periphery of the conductor, an element body that contains magnetic particles and a resin and includes the coil conductor, and an outer electrode connected to an exposed part of the extended portion. The exposed part is exposed from a surface of the element body. In at least one of the pair of extended portions, in the exposed part, the conductor of the conductive wire is exposed from an opening of the insulating coating and extends on the surface of the element body, and an area of an exposed surface of the conductor extending on the surface of the element body is larger than an area of the opening of the insulating coating.

Another aspect of the present disclosure provides a manufacturing method for an inductor. The manufacturing method includes a step of embedding a coil conductor having a pair of extended portions in an element body containing magnetic particles and a resin such that the extended portions of the coil conductor are exposed from a surface of the element body, a step of removing an insulating coating of a conductive wire of the coil conductor along the surface of the element body to form an opening of the insulating coating by grinding or polishing the surface of the element body from which the extended portion is exposed, and pressing and spreading a conductor of the conductive wire exposed from the opening of the insulating coating on the surface of the element body to form an exposed surface of the conductor, and a step of forming an outer electrode on the surface of the element body including the exposed surface.

According to the present disclosure, it is possible to suppress formation of the outer electrode on the insulating coating of the extended portion exposed at the surface of the element body to improve adhesion strength between the extended portion and the outer electrode and reduce direct current resistance in the inductor in which the coil conductor having the pair of extended portions formed of the conductive wire having the conductor and the insulating coating is included in the element body containing the magnetic particles and the resin.

### BRIEF DESCRIPTION OF THE DRAWINGS

FIG. 1 is a perspective view of an inductor according to an embodiment of the present disclosure as viewed from a top surface side;

FIG. 2 is a perspective view of the inductor as viewed from a bottom surface side;

FIG. 3 is a see-through perspective view depicting an internal configuration of the inductor;

FIG. 4 is a see-through plan view of the inductor depicted in FIG. 3 as viewed from the top surface side;

FIG. 5 is a diagram of the inductor depicted in FIG. 4 as viewed from an end surface side;

FIG. 6 is a sectional view taken along line V-V of the inductor depicted in FIG. 5;

FIG. 7 is a micrograph of the end surface of an element body in the middle of manufacturing the inductor;

FIG. 8 depicts an example of a configuration in which an extended portion is inclined toward the interior of the element body with respect to the end surface of the element body in the middle of manufacturing the inductor;

FIG. 9 is an enlarged cross-sectional photograph depicting a boundary part between the extended portion and an outer electrode; and

FIG. 10 is a diagram depicting a manufacturing process for the inductor.

### DETAILED DESCRIPTION

An embodiment of the present disclosure is described below with reference to the drawings.

### 1. Configuration of Inductor

First, a configuration of an inductor 1 according to the present embodiment is described.

### 1.1 Overall Configuration of Inductor

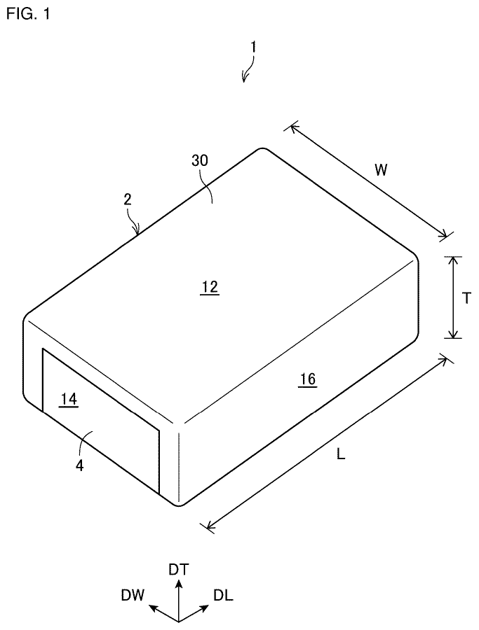

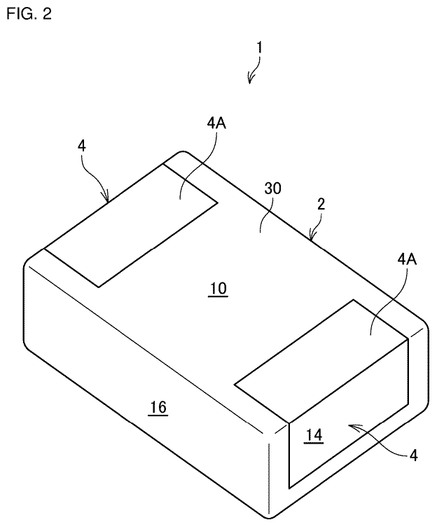

FIG. 1 is a perspective view of the inductor 1 according to the present embodiment as viewed from a top surface 12 side. FIG. 2 is a perspective view of the inductor 1 as viewed from a bottom surface 10 side.

The inductor 1 of the present embodiment is configured as a surface-mount electronic component, and includes an element body 2 having a substantially rectangular parallelepiped shape, which is a form of a substantially hexahedral shape, and a pair of outer electrodes 4 disposed on a surface of the element body 2.

Hereinafter, in the element body 2, a first main surface that is oriented toward a mounting substrate (not depicted) in mounting is defined as the bottom surface 10, and a second main surface opposed to the bottom surface 10 is referred to as the top surface 12. Further, a pair of third main surfaces orthogonal to the bottom surface 10 are referred to as end surfaces 14, and a pair of fourth main surfaces orthogonal to the bottom surface 10 and the pair of end surfaces 14 are referred to as side surfaces 16.

As depicted in FIG. 1, a distance from the bottom surface 10 to the top surface 12 is defined as a thickness T of the element body 2. A distance between the pair of side surfaces 16 is defined as a width W of the element body 2. A distance between the pair of end surfaces 14 is defined as a length L of the element body 2. Further, a direction of the thickness T is defined as a thickness direction DT. A direction of the width W is defined as a width direction DW. A direction of the length L is defined as a length direction DL.

A size of the inductor 1 is, for example, such that a dimension of the length L is 1.4 mm, a dimension of the width W is 1.2 mm, and a dimension of the thickness T is 0.65 mm.

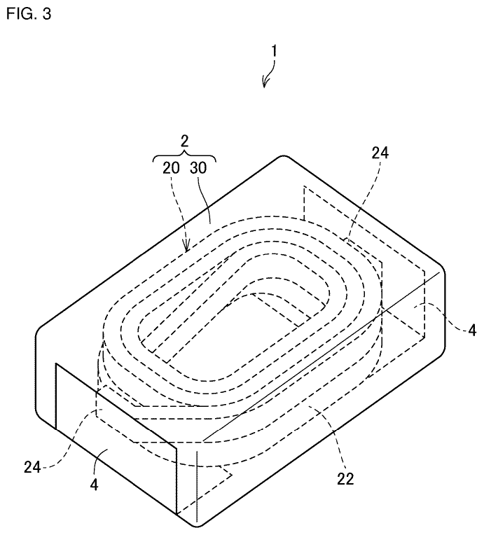

FIG. 3 is a see-through perspective view depicting an internal configuration of the inductor 1.

The element body 2 includes a coil conductor 20 and a substantially hexahedral core 30 in which the coil conductor 20 is embedded, and is configured as a molded inductor in which the coil conductor 20 is enclosed in the core 30.

The core 30 is a molded body that is compression-molded into a substantially hexahedral shape by pressurizing and heating a mixed powder obtained by mixing magnetic particles and a resin in a state in which the coil conductor 20 is included therein.

Further, the magnetic particles of the present embodiment include particles of two types of particle sizes, that is, first magnetic particles that are large particles having a comparatively large average particle diameter and second magnetic particles that are small particles having a comparatively small average particle diameter. Thus, in compression molding, the second magnetic particles, which are the small particles, enter, together with the resin, spaces between the first magnetic particles, which are the large particles. This can increase the filling rate of the magnetic particles in the core 30 and also increase magnetic permeability.

The average particle diameter (D50) of the first magnetic particles is preferably 20 μm or more and 68 μm or less (i.e., from 20 μm to 68 μm), and more preferably 21.4 μm or more and 27.4 μm or less (i.e., from 21.4 μm to 27.4 μm). Further, the average particle diameter (D50) of the second magnetic particles is preferably 1 μm or more and 6 μm or less (i.e., from 1 μm to 6 μm), and more preferably 1.5 μm or more and 1.8 μm or less (i.e., from 1.5 μm to 1.8 μm). Further, the magnetic particles may include particles having an average particle diameter different from those of the first magnetic particles and the second magnetic particles, thereby including particles of three or more types of particle sizes.

Each of the first magnetic particles and the second magnetic particles is a particle having a metal particle and an insulating film that coats a surface of the metal particle and has a film thickness of several nanometers to several tens of nanometers. By coating the metal particles with the insulating film, insulation resistance and a dielectric breakdown voltage are increased.

In the first magnetic particles of the present embodiment, Fe—Si—B amorphous alloy powder is used for the metal particles, and zinc phosphate glass having a thickness of 10 nm or more and 50 nm or less (i.e., from 10 nm to 50 nm) is used for the insulating film. Further, in the second magnetic particles of the present embodiment, carbonyl iron powder is used for the metal particles, and a silica film having a thickness of 5 nm or more and 15 nm or less (i.e., from 5 nm to 15 nm or less) is used for the insulating film.

Further, in the mixed powder of the present embodiment, an epoxy resin containing a phenol-alkyl-type epoxy resin as a main component is used as a material of the resin.

The amount of the second magnetic particles among the magnetic particles contained in the mixed powder is, for example, 15 wt % or more and 30 wt % or less (i.e., from 15 wt % to 30 wt %) on the basis of the total weight of the magnetic particles, and preferably 20 wt % or more and 30 wt % or less (i.e., from 20 wt % to 30 wt %). Further, the resin content of the mixed powder is 2.0 wt % or more and 3.5 wt % or less (i.e., from 2.0 wt % to 3.5 wt %) on the basis of the total weight of the mixed powder.

As depicted in FIG. 3, the coil conductor 20 includes a wound portion 22 obtained by winding a conductive wire and a pair of extended portions 24 extended from the wound portion 22. The coil conductor 20 is not necessarily required to be wound, and may have a linear shape, a meander shape, or the like. In these cases, the coil conductor 20 includes, instead of the wound portion 22, a conductive wire portion having the linear shape or the meander shape and the pair of extended portions 24 extending from the conductive wire portion.

The conductive wire forming the coil conductor 20 has a conductor made of copper and an insulating coating formed on a surface of the conductor. The conductive wire is a strip-shaped conductive wire (a so-called flat conducting wire). The thickness of the conductive wire is 118 μm or less, and preferably 52 μm or more. Further, the width of the conductive wire is 200 μm or less, and preferably 110 μm or more. The aspect ratio of the conductive wire is, for example, 1.2 or more and 3.4 or less (i.e., from 1.2 to 3.4). The insulating coating is, for example, a polyurethane resin, a polyester resin, an epoxy resin, or a polyimide-amide resin, and is preferably a polyimide-amide resin. The thickness of the insulating coating is, for example, 3 μm.

The conductive wire may have, on the insulating coating, a fusion-bonding layer for bonding the conductive wires overlapping each other in the wound portion 22. For example, the fusion-bonding layer is composed of a polyamide resin, and the thickness thereof is preferably 1 μm or more and 25 μm or less (i.e., from 1 μm to 25 μm), more preferably 2 μm or more and 25 μm or less (i.e., from 2 μm to 25 μm), and still more preferably 2 μm or more and 4 μm or less (i.e., from 2 μm to 4 μm).

The wound portion 22 of the coil conductor 20 is formed by spirally winding the strip-shaped conductive wire (hereinafter, also referred to simply as the conductive wire) such that both ends of the conductive wire are extended to an outer periphery and are connected to each other at an inner periphery. Inside the element body 2, the coil conductor 20 is embedded in the core 30 with such a posture that a central axis of the wound portion 22 is oriented along the thickness direction DT of the element body 2. The extended portions 24 are each extended from the wound portion 22 to a respective one of the pair of end surfaces 14. One main surface of the extended portion 24 is exposed from the element body 2, and the other main surface thereof is embedded in the element body 2.

Further, the outer electrodes 4 are electrically connected to exposed parts of the extended portions 24 that are exposed from the surface of the element body 2.

The pair of outer electrodes 4 are each a so-called L-shaped electrode formed of an L-shaped member extending from a respective one of the end surfaces 14 of the element body 2 to the bottom surface 10. The outer electrodes 4 are each connected to the extended portion 24 of the coil conductor 20 at the end surface 14, and a portion 4A (FIG. 2) extending on the bottom surface 10 is electrically connected to a wiring line of a circuit board by an appropriate mounting means such as solder.

Further, an element body protective layer (not depicted in FIGS. 1 to 5) is formed on the surface of the element body 2 except for ranges of the outer electrodes 4. The element body protective layer is, for example, a phenoxy resin and a novolac resin, and contains nano-silica as a filler. The element body protective layer is formed on the surface of the element body 2 with a thickness of 10 μm or more and 30 μm or less (i.e., from 10 μm to 30 μm).

The inductor 1 having such a configuration can improve direct current bias characteristics by using a soft magnetic material for the magnetic particles, and thus is used as an electronic component in an electric circuit through which a large current flows, such as a choke coil in a DC-DC converter circuit or a power supply circuit. Further, the inductor 1 is also used as an electronic component in pieces of electronic equipment, such as personal computers, DVD players, digital cameras, televisions, cellular phones, smartphones, car electronics, and medical and industrial machines. However, applications of the inductor 1 are not limited thereto, and the inductor 1 can also be used for, for example, a tuned circuit, a filter circuit, a rectifying and smoothing circuit, and the like.

### 1.2 Configuration of Boundary Part Between Extended Portion and Outer Electrode

As described above in relation to the background art, in the conventional inductor, the insulating coating of the conductive wire of the extended portion that remains in the vicinity of a contour part of the extended portion exposed at the element body surface (that is, a boundary portion between the surface of the exposed extended portion and the element body surface at the periphery thereof) reduces the connection area between the conductor of the extended portion and the outer electrode, and becomes a portion to which a plated metal does not adhere when the outer electrode is formed by metal plating in a subsequent step. Thus, the remaining insulating coating possibly adversely affects adhesion strength between the extended portion and the outer electrode and direct current resistance.

For this reason, in the inductor 1 according to the present embodiment, in particular, a boundary part between the extended portion 24 and the outer electrode 4 at the surface of the element body 2 is configured as follows.

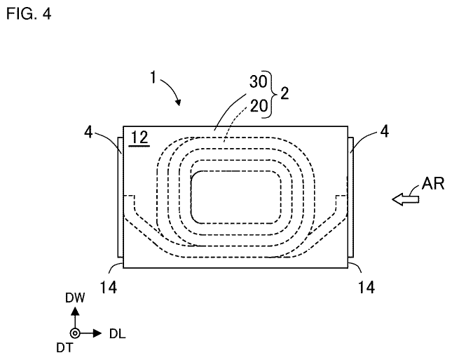

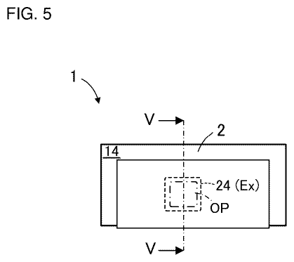

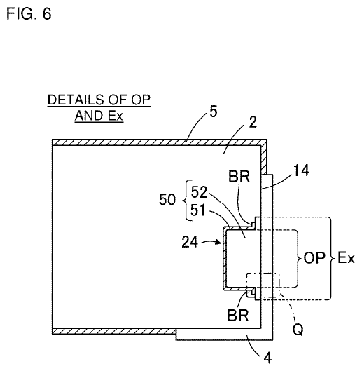

FIG. 4 is a see-through plan view of the inductor 1 depicted in FIGS. 1 and 3 as viewed from the top surface 12 side. FIG. 5 is a diagram of a portion of the end surface 14 on the right side of the drawing in the inductor 1 depicted in FIG. 4, as viewed from the right side of the drawing along a direction of a block arrow AR (−DL direction). Further, FIG. 6 is a cross-sectional view taken along arrows V-V depicted in FIG. 5, and is a diagram depicting a configuration of the boundary part between the extended portion 24 and the outer electrode 4 at the surface of the element body 2.

In FIG. 5, a portion depicted by a dotted-line rectangle represents an exposed part Ex of the extended portion 24 that is exposed from the end surface 14 of the element body 2. Further, a rectangle of a dash-dot line in the drawing represents an opening OP (described later) of an insulating coating 51 of a conductive wire 50 forming the extended portion 24.

Referring to FIG. 6, in the present embodiment, in particular, in the extended portion 24, in the exposed part Ex exposed from the surface of the element body 2, a conductor 52 of the conductive wire 50 is exposed from the opening OP of the insulating coating 51 and extends on the surface of the element body 2 (in the depicted example, on the end surface 14 of the element body 2). Further, the area of an exposed surface of the conductor 52 extending on the surface of the element body 2 (that is, the area of the exposed part Ex) is larger than the area of the opening OP of the insulating coating 51. The area of the exposed part Ex be, for example, 1.1 times or more and 2 times or less (i.e., from 1.1 times to 2 times) of the area of the opening OP of the insulating coating 51.

The above configuration can be formed, for example, as shown in a manufacturing process described later, by grinding or polishing the end surface 14 from which the extended portion 24 is exposed in the surface of the element body 2 to remove the insulating coating 51 of the conductive wire 50, and pressing and spreading the conductor 52 exposed from the insulating coating 51 along the surface of the element body 2.

As depicted in FIG. 6, at an edge portion of the opening OP of the insulating coating 51 in the exposed part Ex, a burr BR of the insulating coating 51 may be generated toward the outer side of the opening OP. When the burr BR is generated in a step of the grinding or the polishing, the conductor 52 can be pressed and spread at the surface of the element body 2 into such a size as to cover the burr BR.

With the above configuration, in the exposed part Ex of the extended portion 24, the conductor 52 of the extended portion 24 spreads and extends over the surface of the element body 2 in such a manner as to cover most or the entirety of the insulating coating 51 present at the edge portion of the opening of the insulating coating 51. Accordingly, in the inductor 1 having the above configuration, exposure of the insulating coating 51 in the exposed part Ex of the extended portion 24 of the coil conductor 20 that is exposed at the surface of the element body 2 can be effectively suppressed, and thus the adhesion strength between the extended portion and the outer electrode can be improved and the direct current resistance can be reduced.

The area of the exposed part Ex and the area of the opening OP can be measured as follows. First, imaging is performed from the end surface 14 side of the element body 2 using a computed tomography (CT) apparatus, and frames of CT images are advanced from a central portion of the element body 2 to the first CT image that allows the opening OP of the insulating coating 51 to be discerned, thereby specifying a measurement image for the area of the opening OP of the insulating coating 51. Thereafter, the frames of the CT images are further advanced to the first CT image that allows the exposed surface of the conductor 52 to be discerned, thereby specifying a measurement image for the exposure area of the conductor 52. Then, each measurement image is loaded into image software (myVGL (manufactured by Volume Graphics, Inc.)), and the area is measured in comparison with a scale provided to the CT image, whereby the respective areas of the opening OP and the exposed surface of the conductor 52 can be measured.

Further, in the inductor 1, as depicted in FIG. 5, it is preferable that the opening OP of the insulating coating 51 be covered with the conductor 52 of the extended portion 24 extending on the surface of the element body 2 to make a state in which the insulating coating 51 is not exposed at all at the surface of the element body 2. Such a configuration can be formed by performing grinding or polishing such that an abrasive tool moves in a circular motion relative to the element body 2 when the end surface 14 of the element body 2 from which the extended portion 24 is exposed is ground or polished.

Thus, in the inductor 1, it is possible to prevent exposure of the insulating coating 51 in the exposed part Ex of the extended portion 24 of the coil conductor 20 that is exposed at the surface of the element body 2, and to improve the adhesion strength between the extended portion 24 and the outer electrode 4 and further effectively reduce the direct current resistance.

Further, a boundary line between the exposed surface of the conductor 52 extending on the surface of the element body 2 and the surface of the element body 2 (that is, an outer peripheral boundary line of the exposed part Ex of the extended portion 24) may include irregularities.

This makes it possible to secure a larger area as the connection area between the conductor 52 of the extended portion 24 and the outer electrode 4 and further reduce the direct current resistance.

Further, in the exposed part Ex, surface roughness of the exposed surface of the conductor 52 of the extended portion 24 is higher (that is, rougher) than surface roughness of a portion of the conductor 52 of the extended portion 24 where the insulating coating 51 is not removed (for example, a portion of the conductor 52 covered with the insulating coating 51 on the left side of the extended portion 24 in FIG. 6). The surface roughness of the exposed surface of the conductor 52 of the extended portion 24 can be adjusted, for example, on the basis of roughness of the abrasive tool in the grinding or the polishing of the end surface 14 described above.

Thus, the surface roughness of an interface surface between the conductor 52 of the extended portion 24 and the outer electrode 4 is increased. Accordingly, connection strength between the conductor 52 and the outer electrode 4 can be further improved by an anchor effect that can occur at the interface surface.

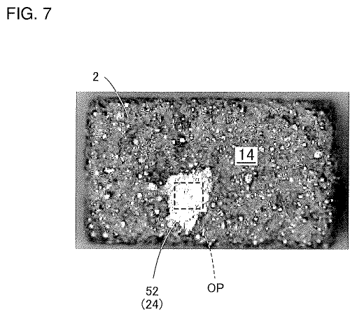

FIG. 7 is a micrograph depicting an example of a state of the end surface 14 of the element body 2 in the middle of manufacturing the inductor 1. A rectangle of a dotted line in the drawing indicates a position of the opening OP of the insulating coating 51 of the extended portion 24. In the depicted example, the conductor 52 of the extended portion 24 extends from the opening OP in four directions along the surface of the element body 2 so as to cover the entire opening OP of the insulating coating 51. Further, in the depicted example, the exposed surface of the conductor 52 is formed in a shape that protrudes downward in the drawing from the opening OP along the surface of the element body 2, and a boundary line between the exposed surface of the conductor 52 and the surface of the element body 2 has irregularities.

Further, from the micrograph depicted in FIG. 7, it can be seen that the exposed surface of the conductor 52 is formed roughly together with the surface of the element body 2 at the periphery thereof.

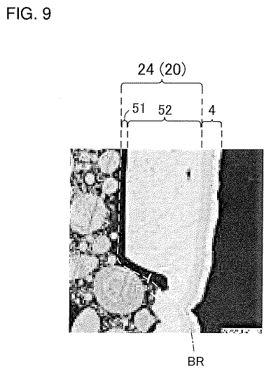

FIG. 9 is a cross-sectional photograph depicting a boundary part between the extended portion 24 and the outer electrode 4 at the surface of the element body 2 of the fabricated inductor 1. The cross-sectional photograph of FIG. 9 corresponds to a cross section of a range of a portion Q depicted in FIG. 6. In the example of FIG. 9, in the insulating coating 51, the burr BR is generated at an end portion on the lower side in the drawing. The conductor 52 extends to the lower side in the drawing beyond the burr BR of the insulating coating 51, and covers the entire insulating coating 51. The boundary between the extended portion 24 and the outer electrode 4 can be more clearly discerned by observing electron channeling contrast in a scanning microscope.

### 2. Manufacturing Process for Inductor

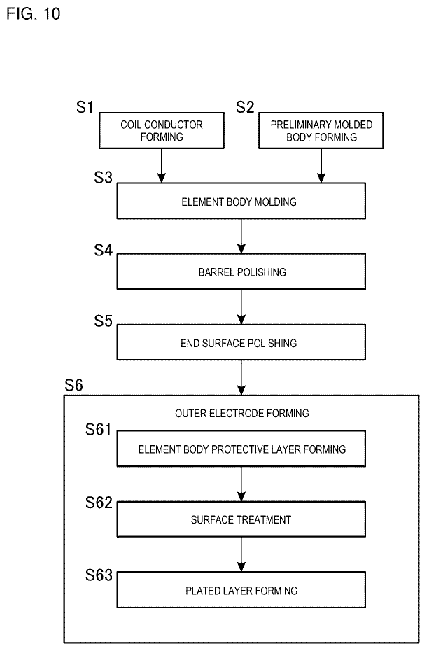

FIG. 10 is a diagram depicting the manufacturing process for the inductor 1.

As depicted in FIG. 10, the manufacturing process for the inductor 1 includes a coil conductor forming step (S1), a preliminary molded body forming step (S2), an element body molding step (S3), a barrel polishing step (S4), an end surface polishing step (S5), and an outer electrode forming step (S6).

The coil conductor forming step (S1) is a step of forming the coil conductor 20 from a conductive wire. In this step, the coil conductor 20 is formed into a shape having the wound portion 22 and the pair of extended portions 24 described above by winding the conductive wire in a way of winding referred to as “alpha winding.” The alpha winding refers to a state in which the conductive wire functioning as a conductor is spirally wound in two layers such that the extended portions 24 at a winding start and a winding end of the conductive wire are located at an outer periphery. The number of turns of the coil conductor 20 is not particularly limited.

The preliminary molded body forming step (S2) is a step of forming a preliminary molded body referred to as a tablet.

The preliminary molded body is an object molded into a solid shape that is easy to handle by pressurizing the above mixed powder, which is a material of the element body 2. In the present embodiment, two types of tablets are formed: a first tablet having an appropriate shape (for example, an E-shape or the like) having a groove into which the coil conductor 20 fits; and a second tablet having an appropriate shape (for example, an I-shape, a plate shape, or the like) that covers the groove of this first tablet.

In the element body molding step (S3), the first tablet, the coil conductor, and the second tablet are set in a molding die. Then, they are cured by performing pressurizing in an overlapping direction of the first tablet and the second tablet while applying heat, and thereby the first tablet, the coil conductor, and the second tablet are integrated. Accordingly, the element body 2 in which the coil conductor 20 is included in the core 30 is molded. The heat molding and curing step corresponds to the element body molding step in the present disclosure.

The barrel polishing step (S4) is a step of performing barrel polishing for this molded body. Corner portions of the element body 2 are rounded by this step.

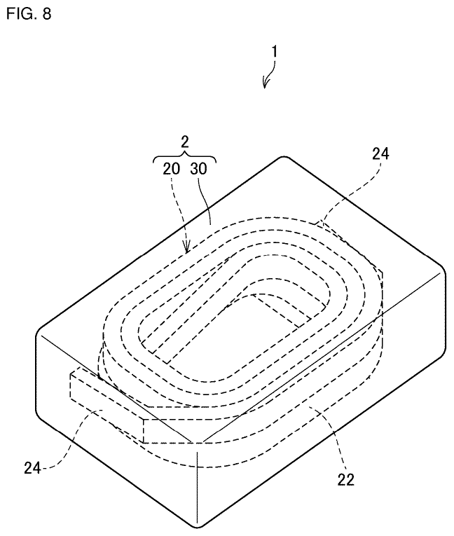

In the end surface polishing step (S5), as depicted in FIG. 8, for the obtained element body 2, the end surfaces of the element body 2 are ground or polished in a state in which the extended portions 24 are exposed, until the length of the element body 2 becomes a predetermined length. Thus, the element body 2 is shaved along the surface thereof, including the extended portions 24. At this time, the insulating coating 51 of the conductive wire 50 of the extended portion 24 is removed along the surface of the element body 2 to form the opening OP of the insulating coating 51. In addition, the conductor 52 of the conductive wire 50 exposed from the opening OP of the insulating coating 51 is pressed and spread along the surface of the element body 2 to form the exposed surface of the conductor 52. At this time, by performing the grinding or the polishing such that the element body 2 moves in a circular manner relative to the abrasive tool, the conductor 52 can be caused to extend in four directions so as to cover the entire opening OP of the insulating coating 51. Further, surface roughness of the exposed surface of the conductor 52 can be adjusted by adjusting roughness of the abrasive tool used for the grinding or the polishing.

The surface roughness of the exposed surface of the conductor 52 and surface roughness of a portion of the conductor 52 where the insulating coating 51 is not removed can be determined by loading an electron channeling contrast photograph obtained by a scanning microscope into image software (VHX, manufactured by KEYENCE CORPORATION) and, with use of a measurement function of the image software, comparing an unevenness status of the exposed surface of the conductor 52 and an unevenness status of the surface of the portion of the conductor 52 where the insulating coating 51 is not removed with a scale of the electron channeling contrast photograph obtained by the scanning microscope.

As depicted in FIG. 8, when the extended portion 24 of the coil conductor 20 embedded in the element body 2 is inclined toward the interior of the element body 2 with respect to the end surface 14, the length of the extended portion 24 exposed at the end surface 14 possibly becomes shorter after polishing of the end surface 14 than that before the polishing.

The outer electrode forming step (S6) is a step of forming the outer electrodes 4 on the core 30, and includes an element body protective layer forming step (S61), a surface treatment step (S62), and a plated layer forming step (S63).

The element body protective layer forming step (S61) is a step of coating the entire surface of this molded body with an insulating resin.

The surface treatment step (S62) is a step of modifying a surface of an electrode formation region on the surface of the core 30 by irradiating the electrode formation region with laser light. Here, the electrode formation region refers to a range in which the outer electrode 4 is to be formed in the surface of the core 30, and includes a portion where the extended portion 24 is exposed. Specifically, by irradiating the electrode formation region with laser light, within the range of the electrode formation region, the element body protective layer on the surface of the core 30 and a coating layer of the extended portion 24 of the coil conductor 20 are removed, and a resin on the surface of the core 30 is removed and an insulating film on surfaces of magnetic particles exposed from the core 30 is removed. Thus, in the portion of the electrode formation region in the surface of the core 30, the exposure area of the metal of the magnetic particles per unit area of the surface of the core 30 becomes larger than that in other surface portions of the core 30. After the irradiation with the laser light, cleaning treatment (for example, etching treatment) for cleaning the surface of the electrode formation region may be performed.

In the plated layer forming step (S63), barrel plating of copper on the surface of the core 30 is performed to form copper plated layers in the electrode formation regions irradiated with the laser light, thereby forming the outer electrodes 4. The outer electrodes 4 may be formed by further disposing Ni plated layers and Sn plated layers over the copper plated layers.

### 3. Other Embodiments

In the above-described embodiment, the extended portion 24, which is a flat conducting wire, is configured such that a side surface of the conductor 52 is exposed at the surface of the element body 2. However, depending on design of the inductor 1, any portion of the extended portion 24 can be exposed at the surface of the element body 2. For example, an end surface of the conductive wire 50 forming the extended portion 24 may be exposed from the surface of the element body 2.

Further, in the present embodiment, the conductive wire 50 forming the coil conductor 20 is a flat conducting wire having a substantially rectangular cross section. However, a cross-sectional shape of the conductive wire 50 may be any shape. For example, the conductive wire 50 may have a circular cross section. In the extended portion 24, a side surface or an end surface of the conductive wire 50 having a circular cross section can be exposed at the surface of the element body 2.

In the above-described embodiment, the outer electrodes 4 are formed as L-shaped electrodes. However, the outer electrode 4 is not limited to the L-shaped electrode, and may be formed as a so-called five-surface electrode that is disposed over the entirety of the end surface 14 and extends to part of each of the bottom surface 10, the top surface 12, and the pair of side surfaces 16 adjacent to the end surface 14. When the five-surface electrode is applied by dipping the core 30 in a conductive resin, the element body protective layer forming step (S61) is not necessarily required.

All of the embodiments and modifications described above illustrate an aspect of the present disclosure, and any modifications and applications can be made without departing from the spirit of the present disclosure.

Further, directions such as horizontal and perpendicular directions and various numerical values, shapes, and materials in the above-described embodiments include ranges that achieve the same operation and effects as these directions, numerical values, shapes, and materials (so-called scope of equivalents) unless otherwise specified.

### 4. Configurations Supported by Above Embodiments

The above-described embodiments support the following configurations.

(Configuration 1) An inductor comprising: a coil conductor having a pair of extended portions formed of a conductive wire having a conductor and an insulating coating covering a periphery of the conductor; an element body that contains magnetic particles and a resin and includes the coil conductor; and an outer electrode connected to an exposed part of the extended portion, the exposed part being exposed from a surface of the element body, wherein in at least one of the pair of extended portions, in the exposed part, the conductor of the conductive wire is exposed from an opening of the insulating coating and extends on the surface of the element body, and an area of an exposed surface of the conductor extending on the surface of the element body is larger than an area of the opening of the insulating coating.

With the inductor of configuration 1, in the exposed part of the extended portion, the conductor of the extended portion spreads and extends over the surface of the element body in such a manner as to cover most or the entirety of the insulating coating present at an edge portion of the opening of the insulating coating. Accordingly, in the inductor of configuration 1, exposure of the insulating coating in the exposed part of the extended portion can be effectively suppressed, and formation of the outer electrode on the exposed insulating coating can be suppressed. Thus, adhesion strength between the extended portion and the outer electrode can be improved and direct current resistance can be reduced.

(Configuration 2) The inductor according to configuration 1, wherein the coil conductor has a wound portion formed by winding the conductive wire and the extended portions extended from the wound portion.

With the inductor of configuration 2, the adhesion strength between the extended portion and the outer electrode can be improved and the direct current resistance can be reduced in the inductor having the wound portion formed by winding the conductive wire.

(Configuration 3) The inductor according to configuration 1 or 2, wherein the opening of the insulating coating is covered with the conductor extending on the surface of the element body, and the insulating coating is not exposed at the surface of the element body.

With the inductor of configuration 3, exposure of the insulating coating in the exposed part of the extended portion can be prevented. Thus, the adhesion strength between the extended portion and the outer electrode can be improved and the direct current resistance can be further effectively reduced.

(Configuration 4) The inductor according to any one of configurations 1 to 3, wherein a boundary line between the exposed surface of the conductor extending on the surface of the element body and the surface of the element body includes irregularities.

With the inductor of configuration 4, it is possible to secure a larger area as the connection area between the conductor of the extended portion and the outer electrode and further reduce the direct current resistance.

(Configuration 5) The inductor according to any one of configurations 1 to 4, wherein in the exposed part of the extended portion, surface roughness of the exposed surface of the conductor is higher than surface roughness of a portion of the conductor where the insulating coating is not removed.

With the inductor of configuration 5, the surface roughness of an interface surface between the conductor of the extended portion and the outer electrode can be increased, and connection strength between the conductor and the outer electrode can be further improved by an anchor effect that can occur at the interface surface.

(Configuration 6) A manufacturing method for an inductor, comprising: a step of embedding a coil conductor having a pair of extended portions in an element body containing magnetic particles and a resin such that the extended portions of the coil conductor are exposed from a surface of the element body; a step of removing an insulating coating of a conductive wire of the coil conductor along the surface of the element body to form an opening of the insulating coating by grinding or polishing the surface of the element body from which the extended portion is exposed, and pressing and spreading a conductor of the conductive wire exposed from the opening of the insulating coating on the surface of the element body to form an exposed surface of the conductor; and a step of forming an outer electrode on the surface of the element body including the exposed surface.

With the manufacturing method of configuration 6, it is possible to effectively suppress exposure of the insulating coating in the exposed part of the extended portion and easily manufacture the inductor in which adhesion strength between the extended portion and the outer electrode is improved and direct current resistance is reduced.

What is claimed is:

1. An inductor comprising:
a coil conductor having a pair of extended portions configured of a conductive wire having a conductor and an insulating coating covering a periphery of the conductor;
an element body that includes magnetic particles and a resin and includes the coil conductor; and
an outer electrode connected to an exposed part of the extended portion, the exposed part being exposed from a surface of the element body, wherein
in at least one of the pair of extended portions, in the exposed part,
the conductor of the conductive wire is exposed from an opening of the insulating coating and extends on the surface of the element body, and
an area of an exposed surface of the conductor extending on the surface of the element body is larger than an area of the opening of the insulating coating.

2. The inductor according to claim 1, wherein
the coil conductor has a wound portion configured by winding the conductive wire and the extended portions extended from the wound portion.

3. The inductor according to claim 1, wherein
the opening of the insulating coating is covered with the conductor extending on the surface of the element body, and the insulating coating is not exposed at the surface of the element body.

4. The inductor according to claim 1, wherein
a boundary line between the exposed surface of the conductor extending on the surface of the element body and the surface of the element body includes irregularities.

5. The inductor according to claim 1, wherein
in the exposed part of the extended portion,
surface roughness of the exposed surface of the conductor is higher than surface roughness of a portion of the conductor where the insulating coating is not removed.

6. The inductor according to claim 2, wherein
the opening of the insulating coating is covered with the conductor extending on the surface of the element body, and the insulating coating is not exposed at the surface of the element body.

7. The inductor according to claim 2, wherein
a boundary line between the exposed surface of the conductor extending on the surface of the element body and the surface of the element body includes irregularities.

8. The inductor according to claim 3, wherein
a boundary line between the exposed surface of the conductor extending on the surface of the element body and the surface of the element body includes irregularities.

9. The inductor according to claim 6, wherein
a boundary line between the exposed surface of the conductor extending on the surface of the element body and the surface of the element body includes irregularities.

10. The inductor according to claim 2, wherein
in the exposed part of the extended portion,
surface roughness of the exposed surface of the conductor is higher than surface roughness of a portion of the conductor where the insulating coating is not removed.

11. The inductor according to claim 3, wherein
in the exposed part of the extended portion,
surface roughness of the exposed surface of the conductor is higher than surface roughness of a portion of the conductor where the insulating coating is not removed.

12. The inductor according to claim 4, wherein
in the exposed part of the extended portion,
surface roughness of the exposed surface of the conductor is higher than surface roughness of a portion of the conductor where the insulating coating is not removed.

13. The inductor according to claim 6, wherein
in the exposed part of the extended portion,
surface roughness of the exposed surface of the conductor is higher than surface roughness of a portion of the conductor where the insulating coating is not removed.

14. The inductor according to claim 7, wherein
in the exposed part of the extended portion,
surface roughness of the exposed surface of the conductor is higher than surface roughness of a portion of the conductor where the insulating coating is not removed.

15. The inductor according to claim 8, wherein
in the exposed part of the extended portion,
surface roughness of the exposed surface of the conductor is higher than surface roughness of a portion of the conductor where the insulating coating is not removed.

16. The inductor according to claim 9, wherein
in the exposed part of the extended portion,
surface roughness of the exposed surface of the conductor is higher than surface roughness of a portion of the conductor where the insulating coating is not removed.

17. A manufacturing method for an inductor, comprising:
embedding a coil conductor having a pair of extended portions in an element body including magnetic particles and a resin such that the extended portions of the coil conductor are exposed from a surface of the element body;
removing an insulating coating of a conductive wire of the coil conductor along the surface of the element body to form an opening of the insulating coating by grinding or polishing the surface of the element body from which the extended portion is exposed, and pressing and spreading a conductor of the conductive wire exposed from the opening of the insulating coating on the surface of the element body to form an exposed surface of the conductor; and
forming an outer electrode on the surface of the element body including the exposed surface.
